(19) United States
(12) Patent Application Publication
(10) Pub. No.: US 2005/0031503 A1
(43) Pub. Date: Feb. 10, 2005

(54) Air ionization control

(76) Inventors: Michael T. Fox, Midland, MI (US); Stacy L. Daniels, Midland, MI (US)

Correspondence Address: LAW OFFICE OF STANLEY K. HILL, PLC, P.O. BOX 52050, MINNEAPOLIS, MN, 55402, US

(21) Appl. No.: 10/634,272

(22) Filed: Aug. 5, 2003

(51) Int. Cl. H05F 3/00; B01J 19/08

(52) U.S. Cl. 422/186.04; 204/164

(57) ABSTRACT

A system for air ionization utilizing a particle sensor to control ionization such that ionization is increased when the particle sensor detects undesirable levels of particulates. Particle sensors utilized in accordance with the present invention also can be effectively utilized in conjunction with other sensors, such as an oxidizable gas sensors or an ozone sensors. In this manner, ionization can be sensor-controlled in that when the aggregate amount of whatever contaminants are detected by the sensors reaches an undesirable level, ionization is increased. Conversely, when the aggregate amount of contaminants detected by the sensors is low, ionization is decreased.

### FIELD OF THE INVENTION

The present invention relates to the application of air ionization for improving air quality within enclosed spaces of a building or vehicle. More specifically, this invention relates to controlling the generation of air ions that improve air quality.

### BACKGROUND AND SUMMARY OF THE INVENTION

Circulated air within enclosed spaces (also referred to herein as rooms), such as those comprising rooms within buildings or cabins within vehicles, often contain undesirable components (that is, contaminants), which collectively define the Indoor Air Quality (“IAQ”) of the enclosed space. It is known in the art that air ionization systems can be utilized to clean air in enclosed spaces by removing or reducing the levels of some of these contaminants in air such as gaseous contaminants (for example, volatile organic compounds (“VOCs”), bio aerosols, and particulates. Air ionization systems known in the art use an air ionizer for generating air ions that can be effective at reducing levels of gaseous contaminants in the air. Air ionization systems known in the art also commonly use filters, such as a high efficiency particulate air (“HEPA”) filter, for reducing levels of particulates in the air. Thus, it is known in the art that that air ionizers can be effective at reducing levels of gaseous contaminants in the air and that HEPA filters can be effective at reducing particulate levels in the air.

It is also known in the art to control the amount of electrical energy provided to an air ionizer, thereby controlling the level of air ionization. One reason for controlling ionization levels is demand driven. That is, if few or no contaminants are present in the air, little or no ionization is needed. However, if contaminant levels are high then an increased level of ionization is needed. A second reason for controlling ionization levels may be to prevent or reduce ozone production. It is known in the art that some types of air ionizers can produce undesirable levels of ozone if the ionization level is too high relative to the amount of contaminants in the air. Additionally, ambient outdoor air introduced into an enclosed space may contain undesirable levels of ozone produced by natural phenomena. One method known in the art for addressing the issue of undesirable ozone levels uses an ozone sensor in conjunction with the air ionizer. The ozone sensor is connected to the air ionizer such that the ionization level is decreased when the ozone sensor detects undesirable levels of ozone. Thus, one method known in the art for controlling air ionization is to utilize an ozone sensor.

Another method known in the art for addressing the issue of undesirable ozone uses a sensor for detecting oxidizable gases, (for example, VOCs or oxidizable inorganic compounds). According to this method, the air ionizer is connected to such a sensor, which detects the oxidizable gas concentration in the air. On the basis of the detected concentration of such oxidizable gases, electrical energy guided to the air ionizer is transformed by an electrical control device in such a way that only lower-level ionization occurs at lower concentrations of oxidizable gases and higher-level ionization occurs at higher concentrations of oxidizable gases. Thus, ionization is sensor-controlled and is automatically increased when the detected concentration of oxidizable gases rises. In this manner, energy is saved and excess ozone is largely avoided when low levels of oxidizable gases are present, yet ionization is increased when the concentration of oxidizable gases rises. The use of an oxidizable sensor has the drawback of not increasing the ionization level when air contaminants are present that are not detectable by the oxidizable gas sensor.

The present invention utilizes a particle sensor to control ionization such that ionization is increased when the particle sensor detects undesirable levels of particulates. It is known that particulates can be removed by electrostatic precipitation onto an electrically charged surface. Surprisingly, it has been discovered that ionization of particulates in the air can be effectively utilized to remove particulate contaminants in air even if no HEPA filter is present. Frequently, air will contain undesirable levels of particulates even if gaseous contaminants, such as oxidizable gases, are not present. Particulates are not measurable by oxidizable gas sensors. Thus, if high particulate levels are present, but low levels of oxidizable gases are present, an ionization device controlled only by an oxidizable gas sensor will not increase ionization even though high levels of contaminants are present (that is, the particulates). A particle sensor utilized in accordance with the present invention also can be effectively utilized in conjunction with other sensors, such as an oxidizable gas sensor or an ozone sensor. In this manner, ionization is sensor-controlled in that when the aggregate amount of whatever contaminants are detected by the sensors reaches an undesirable level, ionization is increased. Conversely, when the aggregate amount of contaminants detected by the sensors is low, ionization is decreased.

### DESCRIPTION OF THE DRAWINGS

The present invention is illustrated by way of example in the following drawings in which like references indicate similar elements. The following drawings disclose various embodiments of the present invention for purposes of illustration only and are not intended to limit the scope of the invention.

FIG. 1a shows a side view of an ionization tube known in the art.

FIG. 1b shows a cross-sectional view of the ionization tube of FIG. 1a.

FIG. 2 shows a diagram of an ionization system of the present invention.

FIG. 3 shows a diagram of an air ionizer of the present invention.

FIG. 4 shows a diagram of an IAQ monitor of the present invention.

FIG. 5 shows a diagram of an operator interface of the present invention.

FIG. 6 shows a diagram of a control unit of the present invention.

### DETAILED DESCRIPTION OF PREFERRED EMBODIMENTS OF THE INVENTION

In the following detailed description of preferred embodiments of the present invention, reference is made to the accompanying Drawings, which form a part hereof, and in which are shown by way of illustration specific embodiments in which the present invention may be practiced. It should be understood that other embodiments may be utilized and changes may be made without departing from the scope of the present invention.

In one embodiment, the present invention is a system for air ionization. Generally, air ionization systems of the present invention comprise one or more air ionizers, an electrical power source sufficient to power the air ionizer(s), one or more air contaminant sensors, and a control unit electrically connected to the air ionizer(s), to the electrical power source, and to the sensor(s). The control unit of the present invention controls the amount of air ionization based on the air contaminants levels determined by the sensor(s).

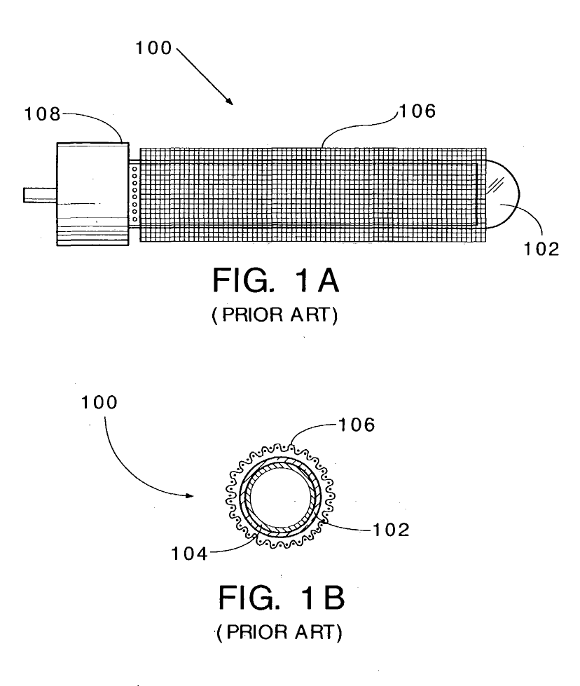

Generally, air ionizers useful in the present invention can be any device known in the art to generate air ions. For example, ionization can be performed in accordance with the present invention by dielectric barrier discharge (“DBD”) or by corona discharge (“CD”). In one preferred embodiment of the present invention DBD devices are utilized. DBD devices incorporate barriers of a dielectric material placed between electrodes and have been configured as cylinders, flat plates, and packed beds of granular dielectric or ferroelectric media. One particularly useful configuration is a cylindrical glass tube placed between an outer electrode and an inner electrode, referred to herein as an ionization tube. Glass, being a dielectric material, acts as a barrier to the applied electric field. For illustrative purposes, FIGS. 1a and 1b show an example of an ionization tube known in the art, wherein the known ionization tube comprises essentially a glass tube 102, wherein a perforated metal plating 104 is electrically conductively disposed on the inside of the glass tube 102 and a wire mesh 106 is electrically conductively disposed on the outside of glass tube 102. In the general process known as dielectric barrier discharge, a high voltage is connected to the metal plating 104 and the wire mesh 106, which are insulated from each other. A transformer 108 generates the high voltage. A capacitor is formed, wherein the capacitance faces of the capacitor are formed by the metal plating 104 and the wire mesh 106, wherein the wall of the glass tube 102 represents the dielectric. During operation, a so-called “silent discharge” occurs when an electric alternating voltage of, for example, 2800 volts from the transformer 108 is applied to the interior metal plating 104 then discharged through the wall of the glass tube 102 to the exterior grounded wire mesh 106. This process also generates ozone (O₃), which can be smelled at concentrations of only about 30 ppb and which can be damaging to health in higher concentrations from about 100 ppb. Examples of ionization tubes useful in the present invention include D-tubes, E-tubes, and F-tubes available from Bentax of North America.

Air ionization systems according to the present invention also comprise an electrical power source. Generally, the power source can exert sufficient electrical power to cause the air ionizer to generate active air ions. In one preferred embodiment of the present invention, the electrical power source comprises a 120 volt AC power supply such as is commonly found in residential housing, commercial buildings, and other facilities throughout North America.

Air ionization systems of the present invention comprise a particle sensor. Particle sensors useful in the present invention are those sensors that can generate an output signal having a level that is proportional to the amount of particulate matter detected in the air. Particle sensors useful in air ionization systems of the present invention include condensation particle counters and optical particle sensors, such as light scattering types. Condensation particle counters generally can detect particulates from about 0.003 micrometers in size to about 1 micrometer. Optical sensors generally can detect particulates from about 0.3 micrometers in size to about 10 micrometers or even larger. The types of particulates detectable by preferred particle sensors include smoke, pollen, dust, mold spores, and fibers.

One example of a particle sensor useful in air ionization systems of the present invention is Particle Sensor Unit PPD20V, available from Shinyei. This sensor is of the light scattering type. Light emitted from a light emitting diode is focused toward a sensing point. Air containing particulates passes through the sensing point. A receptor lens detects the light reflected off particles at the sensing point in the form of flashes and produces a pulse depending on each received flash from the sensing point. Pulse per unit time is proportional to the level of airborne particulates in the air.

Air ionization systems of the present invention may advantageously comprise one or more other sensors in addition to the particle sensor. The other sensors include, for example, oxidizable gas sensors, ozone sensors, humidity sensors, airflow sensors, and ion sensors. In one preferred embodiment, air ionization systems of the present invention comprise an oxidizable gas sensor in addition to a particle sensor. The oxidizable gas sensor may be any oxidizable gas sensor known in the art, such as a VOC sensor.

One example of oxidizable gas sensors useful in air ionization systems of the present invention are the oxidizable gas sensors taught in U.S. Pat. No. 6,375,714. In these sensors, a heated sensor element, such as a metal oxide semiconductor sensor, operates like an electrical resistance. The electrical resistance assumes a value corresponding to uncontaminated air. If oxidizable vapors are present in the air, then the electrical resistance drops to a value corresponding to the gas concentration. Thus, the change in resistance is a measure of the level of gaseous contaminants in the air. Another example of an oxidizable gas sensor useful in the present invention is the TGS 2600 available from Figaro USA, Inc. The sensing element of the TGS 2600 comprises a metal oxide semiconductor layer formed on an alumina substrate of a sensing chip together with an integrated heater. In the presence of a detectable gas, the sensor's conductivity increases depending on the gas concentration in the air. A simple electrical circuit can convert the change in conductivity to an output signal that corresponds to the gas concentration.

Air ionization systems of the present invention comprise a control unit. Control units of the present invention are electrically connected to the air ionizer(s), the power source, and the sensor(s), such that the control unit controls the level of the ionization based on signals received from the sensor(s). Generally, the control unit receives signals from the sensor(s) and, based on these signals, adjusts the amount of electrical energy supplied to the air ionizer(s), thereby adjusting the amount of ionization. In a preferred embodiment, the amount of electrical energy supplied to the air ionizer(s) is controlled by adjusting the length of electrical pulses to the air ionizer(s). For example, if a particle sensor detects a high level of particulate contamination, the particle sensor signal to the control unit will indicate the high level of particulate contamination and the control unit will generally increase the energy (for example, increase the length of electrical pulses) to the air ionizer, thereby increasing the level of ionization. If the ionization level is already at some predetermined maximum allowable level, then increased particulate detection will not increase the ionization level.

For example, in one embodiment of the present invention, the output of the control unit is in the form of 120 volts AC pulses with the output level being based on a two-second time period. That is, if the output level of the control unit is at 50 percent, then the pulse is “on” for one second and “off” for one second. Accordingly, a maximum output level of 99 percent has the pulse “on” for 1.98 seconds of each two-second period. The control units sets the output level (that is, the length of the “on” pulses) depending on manually entered parameters and the sensor inputs to the control unit.

Similarly, higher levels of gaseous contaminants detected by a gas contaminant sensor generally result in the control unit increasing the amount of ionization by increasing the amount of electrical energy supplied to an air ionizer. Conversely, if an ozone level detects undesirable levels of ozone in the air, then the control unit can decrease the amount of ionization based on the level of ozone detected by decreasing the amount of electrical energy supplied to an air ionizer. When multiple sensors are utilized, the control unit may control the ionization level based on the aggregate levels detected by the sensors, for example.

Control units may comprise, for example, microprocessors or programmable logic circuits (“PLCs”). Thus, methods for transforming sensor signal inputs into electrical energy levels can be programmed into the control unit and later modified as needed or as more optimized algorithms for determining needed electrical energy based levels on sensor signals are developed.

### EXAMPLES

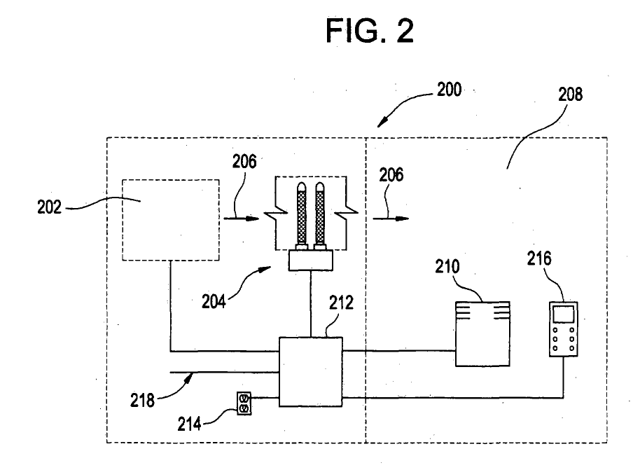

FIGS. 2-6 illustrate an example of an air ionization system of the present invention. FIG. 2 shows a diagram of and embodiment of the air ionization system 200 as it might be utilized in conjunction with a heating/air-conditioning system (“HVAC”) 202 as is typically found in residential building, commercial buildings, and institutional buildings. Generally, the air ionizer 204 is placed in the ductwork of the HVAC system such that the air flowing through the ductwork is ionized during operation of the air ionization system. In FIG. 2, the arrows 206 indicate the airflow from the HVAC system 202 into a room 208. An IAQ monitor 210, comprising one or more sensors in accordance with the present invention, is placed inside the room 208. The sensors in the IAQ monitor 210 determine various levels of contaminants in the air and send signals corresponding to the determined levels to the control unit 212. The control unit 212 is electrically connected to the power source 214 such that the control unit 212 can control the amount of ionization by controlling the amount of electrical energy to the air ionizer 204. Optionally, the control unit 212 may be connected to the HVAC system 202 to allow the control unit 212 to receive system status signals from the HVAC system 202, such as humidity, temperature, and fan speed (or air flow volume), for example. Air ionization systems according to the present invention may also comprise an operator interface such as the operator interface 216 shown in FIG. 2. The operator interface 216 can be connected to the control unit 212 via any means known in the art. For example, the operator interface 216 can be connected to the control unit 212 via a serial communication such as a RS232 serial communication, via a wireless communication, or can be an integral part of the control unit 212.

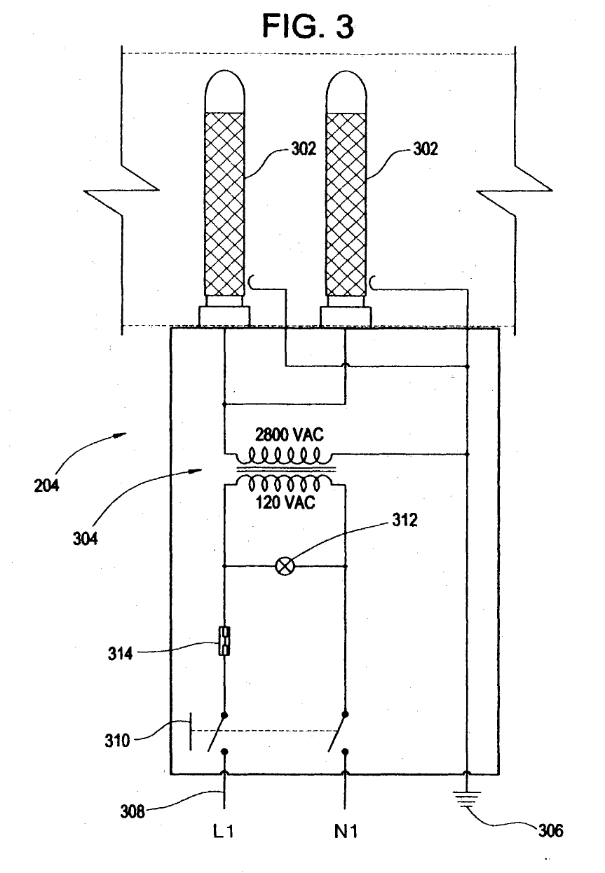

FIG. 3 shows a more detailed diagram of the air ionizer 204 shown in FIG. 2. The air ionizer 204 comprises two ionization tubes 302 electrically connected to a transformer 304 and a ground 306. Air ionizers that comprise ionization tubes may comprise any number of ionization tubes. For example, air ionization systems of the present invention used in residential applications will frequently have air ionizers that comprise four or, even more frequently, six ionization tubes. Signal line N1 is a pulsed 120-volt AC signal received from the control unit 212. Also shown in FIG. 3 is a disconnect switch 310, an operating light 312, and a fuse 314. When the disconnect switch 310 is closed the air ionizer 204 is electrically connected to the control unit 212 and when the disconnect switch 310 is open the air ionizer 204 is disconnected from the control unit 212. The operating light 312 is lit to indicate when the air ionizer 204 is operating (that is, ionizing). That is, when the disconnect switch 310 is closed and the fuse 314 is operating, then the air ionizer 204 receives a pulse from the control unit 212, the ionization tubes are activated, and the operating light 312 is lit.

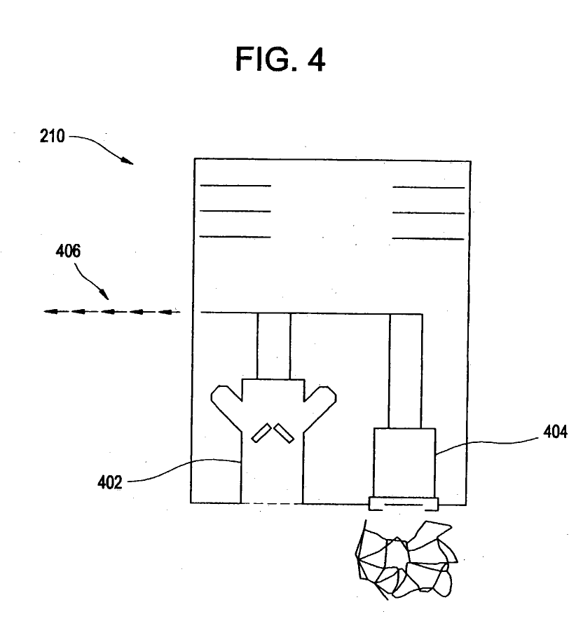

FIG. 4 shows a more detailed diagram of the IAQ monitor 210 shown in FIG. 2. The IAQ monitor 210 comprises a particle sensor 402 and an oxidizable gas sensor 404. The particle sensor 402 determines the level of particulates in the air and sends a corresponding signal to the control unit 212 as indicated by the arrows 406 in FIG. 4. The oxidizable gas sensor 404 determines the level of oxidizable gas in the air and sends a corresponding signal to the control unit 212 as indicated by the arrows 406.

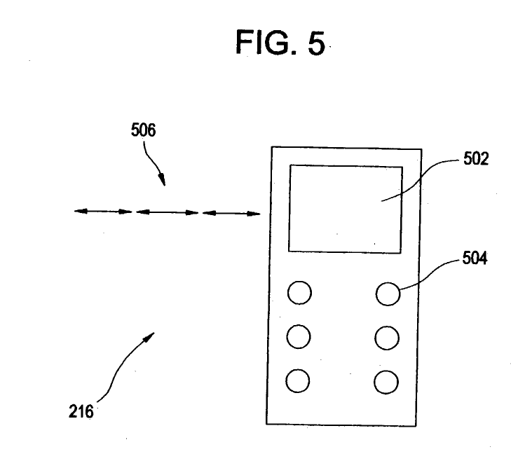

FIG. 5 shows a more detailed diagram of the operator interface 216 shown in FIG. 2. The operator interface 216 is a device that comprises a display 502 for displaying information to the operator and buttons 504 that enable an operator to input data into the device. The operator interface 216 is connected to the control unit 212 as indicated by the arrows 506 in FIG. 5. The information received from the control unit 212 and displayed by the operator interface 216 may include, for example, output intensity levels of the air ionizer 204, IAQ measurements as determined by the sensor(s), HVAC system status (temperature, humidity, fan speed, etc.), or other operational settings. Generally, an operator of the operator interface 216 will use the operator interface 216 to input data into the system 200 during initialization of the system 200. For example, an operator of the operator interface 216 may input desired baseline ionization intensity levels, existing airflow volumes, and other operator parameters.

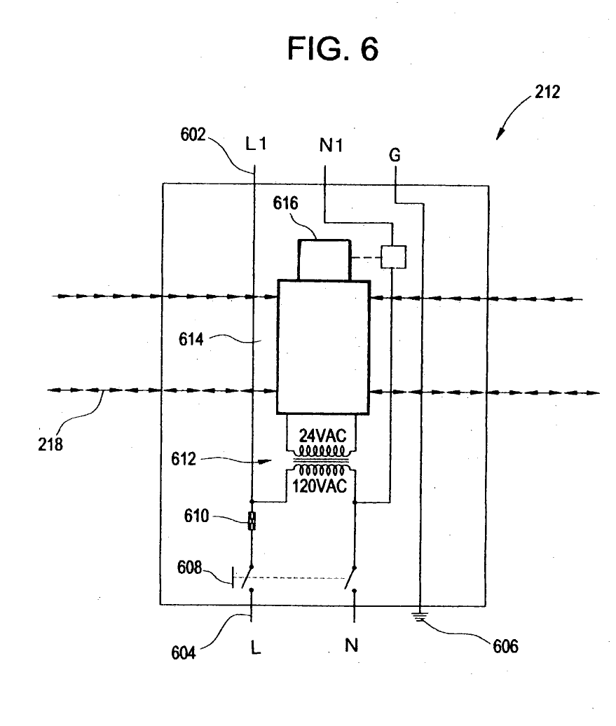

FIG. 6 shows a more detailed diagram of the control unit 212 shown in FIG. 2. The control unit 212 is electrically connected to the air ionizer 204 via a pulsed 120-volt AC signal line N1, electrically connected to the power source 214 via a power line L 604, and electrically connected to a ground 606. Line L1 602 is electrically connected to the air ionizer's 204 line L1 308 and the control unit's 212 signal line N1 is electrically connected to the air ionizer's 204 signal line N1. The control unit 212 further comprises a disconnect switch 608 similar to the disconnect switch 310 of the air ionizer 204, a fuse 610 similar to the fuse 314 of the air ionizer 204, a transformer 612, a microprocessor 614, and an output signal relay 616. The power to operate the IAQ monitor 210 is obtained from 5-volt DC and 24-volt DC power supplies (not shown) located in the system controller.

In the control unit 212, the transformer 612 reduces the 120-volt AC power source to 24-volt AC to power the microprocessor 614 circuitry. The same 120-volt AC power source 214 that powers the control unit 212 is also used to power the air ionizer 204. The 120-volt AC power source is switched on and off, or pulsed, to the air ionizer 204 by the output signal relay 616. The output signal relay 616 is controlled by a digital output from the microprocessor 614. In the air ionizer 204, the transformer 304 transforms the 120-volt AC power source to approximately 2800 volts to power the ionization tubes 302.

To customize the control unit 212 to its particular installation, parameters such as number of ionization tubes in the air ionizer, baseline intensity, airflow values for each mode of operation (heat, cool, fan speed, duct area, etc.), for example, can be entered into the microprocessor via the operator interface 216. The microprocessor 614 can also be preset with default values for these parameters. The microprocessor 614 receives analog inputs (that is, sensor inputs) from the particle sensor 402 and the gaseous contaminant sensor 404 located in the IAQ monitor 210. The sensor inputs and the parameter settings are used by the microprocessor 614, to determine the digital output that controls the output signal relay 616, producing an intensity level in the form of a pulsed power to the air ionizer 204. That is, the intensity level is defined by the length of the power pulses to the air ionizer 204, where a longer pulse creates a higher intensity level.

Information such as intensity level, sensor readings, and system settings can be sent from the control unit 212 to the operator interface 216. Optionally, the control unit 212 can be connected to a larger network via a network interface 218 such as is shown in FIG. 2 and FIG. 6. In one embodiment, the control unit 212 is connected to the Internet via the network interface 218. In this manner, the operation of the air ionization device 200 can be remotely monitored or even modified. For example, information can be sent over the Internet to monitor for safety reasons (ozone detection, for example) or to collect information over time in an effort to check on the general operation of the air ionization device. Additionally, the latest versions of software running on the microprocessor 614 can be downloaded via the network interface 218.

While the present invention has been described in detail with respect to specific embodiments thereof, it will be appreciated that those skilled in the art, upon attaining an understanding of the foregoing, may readily conceive of alterations to, variations of and equivalents to these embodiments. Accordingly, the scope of the present invention should be assessed as that of the appended claims and by equivalents thereto.

1. A system for air ionization, comprising:
an air ionizer;
an electrical power source;
a particle sensor for determining particulate levels in air; and
a control unit connected to the air ionizer, to the power source, and to the particle sensor, wherein the control unit utilizes signals from the particle sensor to control an amount of electrical energy supplied to the air ionizer.

2. A system according to claim 1, wherein the control unit controls the amount of electrical energy by pulsing the electrical power source.

3. A system according to claim 1, wherein the air ionizer comprise one or more ionization tubes.

4. A system according to claim 1, further comprising an ozone sensor, wherein the control unit utilizes signals from the particle sensor and the ozone sensor to control the amount of electrical energy

5. A system for air ionization, comprising:
an air ionizer;
an electrical power source;
a particle sensor for determining particulate levels in air;
an oxidizable gas sensor for determining concentrations of oxidizable gas in air; and
a control unit connected to the air ionizer, to the power source, to the particle sensor, and to the oxidizable gas sensor, wherein the control unit utilizes signals from the particle sensor and the oxidizable gas sensor to control an amount of electrical energy supplied to the air ionizer.

6. A system according to claim 5, wherein the control unit controls the amount of electrical energy by pulsing the electrical power source.

7. A system according to claim 5, wherein the air ionizer comprise one or more ionization tubes.

8. A system according to claim 5, further comprising an ozone sensor, wherein the control unit utilizes signals from the particle sensor, the oxidizable gas sensor, and the ozone sensor to control the amount of electrical energy.

9. A method for improving air quality, comprising the steps of:
ionizing the air;
determining the particulate level in the air; and
utilizing the determined particulate level to control the amount of ionizing.

10. A method according to claim 9, further comprising the step of determining the ozone level in the air, wherein the utilizing step utilizes the determined particulate level and the determined ozone level to control the amount of ionizing.

11. A method for improving air quality, comprising the steps of:
ionizing the air;
determining the particulate level in the air;
determining the concentration of oxidizable gas in the air and
utilizing the determined particulate level and the determined oxidizable gas concentration to control the amount of ionizing.

12. A method according to claim 11, further comprising the step of determining the ozone level in the air, wherein the utilizing step utilizes the determined particulate level, the determined oxidizable gas concentration, and the determined ozone level to control the amount of ionizing.
